(19) United States
(12) Patent Application Publication
(10) Pub. No.: US 2026/0120532 A1
(43) Pub. Date: Apr. 30, 2026

(54) ENTRANCE SECURITY MANAGEMENT APPARATUS AND METHOD FOR SELF-DRIVING ROBOTS

(71) Applicants: HYUNDAI MOTOR COMPANY, Seoul (KR); Kia Corporation, Seoul (KR); SUNGSHIN WOMEN'S UNIVERSITY R&DB FOUNDATION, Seoul (KR)

(72) Inventors: Jaehoon You, Hwaseong-si (KR); Soomin Shim, Hwaseong-si (KR); Won Hee Kim, Hwaseong-si (KR); Seong Wook Hwang, Seoul (KR); Joon Young Kim, Seoul (KR); Namgyo Kim, Chuncheon-si (KR); Yujin Song, Dongducheon-si (KR); Hyo Jin Song, Incheon (KR); Sihyeon Park, Chungju-si (KR); Jeong Min Oh, Seoul (KR)

(73) Assignees: HYUNDAI MOTOR COMPANY, Seoul (KR); Kia Corporation, Seoul (KR); SUNGSHIN WOMEN'S UNIVERSITY R&DB FOUNDATION, Seoul (KR)

(21) Appl. No.: 19/081,246

(22) Filed: Mar. 17, 2025

(30) Foreign Application Priority Data
Oct. 29, 2024 (KR) 10-2024-0149490

(51) Int. Cl. G07C 9/00; G05D 1/24; G05D 107/60; G05D 109/10; G05D 111/30

(52) U.S. Cl. CPC G07C 9/00571; G05D 1/24; G07C 9/00309; G05D 2107/60; G05D 2109/10; G05D 2111/32; G07C 2009/00793; G07C 2209/63

(57) ABSTRACT

An entrance security management apparatus for a self-driving robot is provided. The entrance security management apparatus includes a robot that autonomously drives along a path, an entrance security terminal placed at an entrance door in a building and controlling opening and closing of the entrance door, a robot control server checking a current location of the robot and an entrance door matched to the current location and transmitting an opening request for the entrance door, and an entrance security terminal management server generating an opening code for the entrance door upon receiving the opening request and transmitting an opening command for the entrance door to the entrance security terminal based on the generated opening code.

### CROSS-REFERENCE TO RELATED APPLICATION(S)

This application claims priority to and the benefit of Korean Patent Application No. 10-2024-0149490 filed in the Korean Intellectual Property Office on Oct. 29, 2024, the entire contents of which are incorporated herein by reference.

### TECHNICAL FIELD

The disclosure relates to an entrance security management apparatus and method for a self-driving robot. In an example embodiment, an entrance security management apparatus and method for a self-driving robot opens and closes an entrance door through communication between an entrance security management server of a building and a control server of a self-driving robot.

### BACKGROUND

Control systems and/or methods for an automatic door or speed gate through an entrance door control Bluetooth (or RFID) module may impact the appearance of a building's interior and additional costs, for equipment and/or installation, may be incurred to provide a building with such a system.

The method for linking control of an automatic door server or speed gate server and a robot control server also may incur development costs for each site or building if an external system linking server and/or an external interface protocol is absent.

### SUMMARY

This disclosure provides an entrance security management apparatus and method for a self-driving robot provided to (e.g., unidirectionally) open and close an (e.g., entrance) door to which an entrance security terminal is connected, regardless of type and model, through a relay contact signal.

This disclosure provides an entrance security management apparatus and method for a self-driving robot capable of opening and closing an (e.g., unspecified) entrance door through communication between an entrance security terminal management server and a robot control server by making an entrance security terminal between a robot and an entrance door a gateway.

This disclosure provides an entrance security management apparatus and method for a self-driving robot capable of (e.g., immediately) communicating with the robot without additional development in a building in which the same entrance security terminal is introduced when linked with an entrance security terminal management server.

This disclosure provides an entrance security management apparatus and method for a self-driving robot, and avoids incurring additional installation and/or development costs and avoids negatively impacting the appearance of doors and/or buildings.

According to an example embodiment, an entrance security management apparatus for a self-driving robot includes a robot that autonomously drives along a path, an entrance security terminal placed at an entrance door (e.g., in a building) to control opening and closing of the entrance door, a robot control server checking a current location of the robot and an entrance door matched to the current location and transmitting an opening request for the (e.g., checked) entrance door, and an entrance security terminal management server generating an opening code for the entrance door (e.g., of the robot) upon receiving the opening request and transmitting an opening command for the entrance door to the entrance security terminal based on the generated opening code.

When the robot arrives at a first waiting area adjacent to a first entrance door located within a first path, the robot may transmit an approval request for a first entrance security terminal matched to the first entrance door to the robot control server along with arrival information including the current location.

When the transmission of the approval request fails due to wireless network delay, the robot may set a second path passing through a second entrance door on the same floor, and when the robot arrives at a second waiting area adjacent to (e.g., near) the second entrance door, the robot may retransmit an approval request for a second entrance security terminal matched to the second entrance door to the robot control server along with arrival information including a current location.

The entrance security terminal may control opening and closing of the entrance door through a wired relay connection to the entrance door.

The robot control server may transmit robot information including a robot code for the robot and entrance security terminal information including an entrance security terminal ID for the entrance door together with the opening request for the entrance door.

The entrance security terminal management server may determine whether to approve opening (e.g., of the entrance door) based on the robot code and the entrance door ID, and when approved, generate the opening code.

The entrance security terminal may open the entrance door according to the opening command and transmit the opening result to the entrance security terminal management server, and the entrance security terminal management server may provide the (e.g., received) opening result to the robot control server.

The robot control server, upon receiving the opening result, may transmit the opening result to the robot, and upon receiving the opening result, the robot may pass through the entrance door.

The robot control server may (e.g., repeatedly) transmit a request to open the entrance door to the entrance security terminal management server until the robot (e.g., completely) passes through the entrance door.

When the robot passes through the entrance door completely, the robot may transmit passage completion information to the robot control server, and when the robot control server receives the passage completion information, the robot control server may stop the repeated transmission of the opening request.

According to example embodiments, an entrance security management method for a self-driving robot includes an operation in which a self-driving robot arrives at a waiting area around (e.g., near) an entrance door within a path and provides arrival information to a robot control server, an operation in which the robot control server checks a current location of the robot and an entrance door matched to the current location and transmits an opening request for the checked entrance door to an entrance security terminal management server, an operation in which the entrance security terminal management server generates an opening code for the entrance door of the robot when the opening request is received, an operation in which an opening command for the entrance door is transmitted to an entrance security terminal placed at the entrance door based on the generated opening code, and an operation in which the entrance security terminal opens the entrance door according to the opening command.

The operation in which the robot provides the arrival information to the robot control server may include an operation in which, when the robot arrives at a first waiting are adjacent to a first entrance door located within a first path, the robot transmits arrival information including the current location and an approval request for a first entrance security terminal matched to the first entrance door to the robot control server.

The operation in which the robot provides the arrival information to the robot control server may further include an operation in which when the transmission of the approval request fails due to wireless network delay, the robot sets a second path passing through a second entrance door on the same floor, and when the robot arrives at a second waiting area adjacent to the second entrance door, the robot retransmits arrival information including a current location and an approval request for a second entrance security terminal matched to the second entrance door to the robot control server.

The operation in which the entrance security terminal opens the entrance door according to the opening command may include an operation in which the entrance security terminal opens the entrance door through a wired relay connection.

The operation in which the opening request for the entrance door is transmitted to the entrance security terminal management server may include an operation in which the robot control server transmits robot information including a robot code for the robot and entrance security terminal information including an entrance security terminal ID for the entrance door (e.g., together) with the opening request for the entrance door.

The operation in which the entrance security terminal management server generates an opening code for the entrance door of the robot may include an operation in which whether to approve opening is determined based on the robot code and the entrance door ID and, when approved, the opening code is generated.

The entrance security management method may further include an operation in which the entrance security terminal opens the entrance door and transmits the opening result to the entrance security terminal management server, and the entrance security terminal management server provides the received opening result to the robot control server.

The entrance security management method may further include an operation in which when the opening result is received, the entrance security terminal management server transmits the opening result to the robot, and an operation in which the robot passes through the entrance door when the opening result is received.

The operation in which the robot control server transmits an opening request for the entrance door to the entrance security terminal management server may include an operation in which the robot control server repeatedly transmits the opening request for the entrance door to the entrance security terminal management server until the robot completely passes through the entrance door.

The operation in which the robot control server repeatedly transmits the opening request for the entrance door to the entrance security terminal management server until the robot completely passes through the entrance door may include an operation in which the robot transmits passage completion information to the robot control server when the robot completely passes through the entrance door and an operation in which the repeated transmission of the opening request is stopped when the robot control server receives the passage completion information.

The entrance security management apparatus and method for a self-driving robot according to an example embodiment of the disclosure may control an (e.g., unspecified) number of entrance doors at once through standardization of a linking protocol between the entrance security management server and the robot control server.

The entrance security management apparatus and method of a self-driving robot according to an example embodiment of the disclosure may digitize an analog-type entrance door by way of an entrance security terminal management server or through a relay signal of an entrance security terminal.

The entrance security management apparatus and method of a self-driving robot according to an example embodiment of the disclosure may reduce additional purchase and installation costs of short-range communication equipment, and/or the like by using an entrance security terminal.

The entrance security management apparatus and method of a self-driving robot according to an example embodiment of the disclosure may (e.g., easily) manage the robot's entrance door entry and exit data and logs through a server linkage method.

### BRIEF DESCRIPTION OF THE DRAWINGS

FIG. 1 is a block diagram of an entrance security management apparatus of a self-driving robot according to an example embodiment of the disclosure.

FIG. 2 is a block diagram of an operation sequence of an entrance security management apparatus of a self-driving robot according to an example embodiment of the disclosure.

FIG. 3 is a block diagram of an entrance security terminal management server according to an example embodiment of the disclosure.

FIG. 4 is a flowchart of an entrance security management method of a self-driving robot according to an example embodiment of the disclosure.

FIG. 5 is a flowchart of an entrance security management method of a self-driving robot according to an example embodiment of the disclosure.

FIG. 6 is a flowchart of an entrance security management method of a self-driving robot according to another example embodiment of the disclosure.

FIG. 7 is a diagram of a computing device according to an example embodiment of the disclosure.

### DETAILED DESCRIPTION

Hereinafter, example embodiments will be described in detail with reference to the accompanying drawings. However, the disclosure may be modified in various different ways, and is not limited to the example embodiments set forth herein. Same or similar reference numerals may designate same or like elements throughout the description.

Throughout the specification and claims, unless described to the contrary, the word “comprise”, and variations such as “comprises” or “comprising”, may be understood to imply the inclusion of stated elements but may not exclude other elements. Although the terms first, second, and/or the like may be used herein to describe various elements, these elements may not be limited by these terms. These terms are used to distinguish one element from another.

The terms “part,” “unit”, and/or “module,” described in the specification refer to a unit capable of processing at least one function or operation described herein and may be implemented by hardware or circuit, software, or a combination of a hardware or circuit and software.

Herein, example embodiments of the disclosure are described with reference to the accompanying drawings.

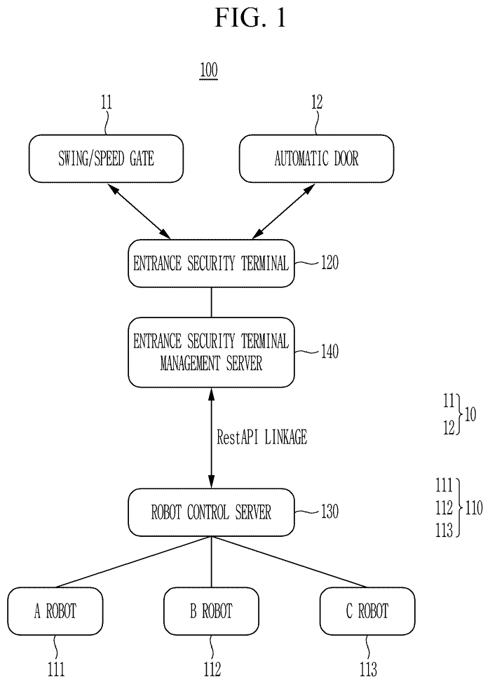

FIG. 1 is a block diagram of an entrance security management apparatus of a self-driving robot according to an example embodiment of the disclosure.

Referring to FIG. 1, an entrance security management apparatus 100 of a self-driving robot includes a robot 110, an entrance security terminal 120, a robot control server 130, and an entrance security terminal management server 140.

In an example embodiment, the robot 110 may be a self-driving robot that autonomously drives along a preset path. The robot 110 may include a plurality of robots that autonomously drive within a building. In an example embodiment, the robot 110 may include an A robot 111, a B robot 112, and a C robot 113, each robot may autonomously drive along different paths.

When the robot 110 arrives at a first waiting area adjacent to a first entrance door located within a first path, the robot 110 may transmit arrival information and an approval request for the first entrance security terminal to the robot control server 130.

The arrival information includes a current location. The first entrance security terminal is matched to the first entrance door.

If the robot 110 fails to transmit the approval request due to wireless network delay, and/or the like, the robot 110 may set a second path that passes through a second entrance door on the same floor.

When the robot 110 arrives at a second waiting area adjacent to the second entrance door, the robot 110 may retransmit the arrival information including the current location and an approval request for a second entrance security terminal to the robot control server 130. The second entrance security terminal is matched to the second entrance door.

When the robot 110 receives an opening result of an entrance door 10 from the robot control server 130, the robot 110 may pass through the entrance door 10.

When the robot 110 completely passes through the entrance door 10, the robot 110 may transmit passage completion information to the robot control server 130.

In an example embodiment, the entrance security terminal 120 is placed on the entrance door 10 in a building and may control opening and closing of the entrance door 10. The entrance door 10 may include a swing/speed gate 11 and an automatic door 12.

The entrance security terminal 120 may be a security device that verifies the identity of a visitor in various manners, such as an employee ID (e.g., RFID), a mobile employee ID (e.g., NFC, Bluetooth), a fingerprint, or a facial recognition, and opens the entrance door if the identity is valid.

The entrance security terminal 120 may control the opening and closing of the entrance door 10 through a wired relay connection with the entrance door 10.

The entrance security terminal 120 may open the entrance door 10 according to an opening command and transmit an opening result or opening information to the entrance security terminal management server 140.

The entrance security terminal management server 140 may provide the received opening result to the robot control server 130.

When the entrance security terminal management server 140 receives an opening request, the entrance security terminal management server 140 may generate an opening code for the entrance door 10 of the robot 110.

The entrance security terminal management server 140 may transmit an opening command of the entrance door 10 to the entrance security terminal 120 based on the generated opening code.

The entrance security terminal management server 140 may determine whether to approve opening based on a robot code and the entrance door ID, and if approved, may generate an opening code.

In an example embodiment, the robot control server 130 may check the current location of the robot 110 and the entrance door 10 matched to the current location and transmit an opening request for the checked entrance door 10.

The robot control server 130 may transmit robot information on the robot 110 and entrance security terminal information for the entrance door 10 along with the opening request for the entrance door 10.

The robot information may include a robot code. The entrance security terminal information may include an entrance security terminal ID.

When the robot control server 130 receives the opening result, the robot control server 130 may transmit the opening result to the robot 110.

The robot control server 130 may repeatedly transmit an opening request for the entrance door 10 to the entrance security terminal management server 140 until the robot 110 completely passes through the entrance door 10.

The robot control server 130 may stop the repeated transmission of the opening request when the passage completion information is received.

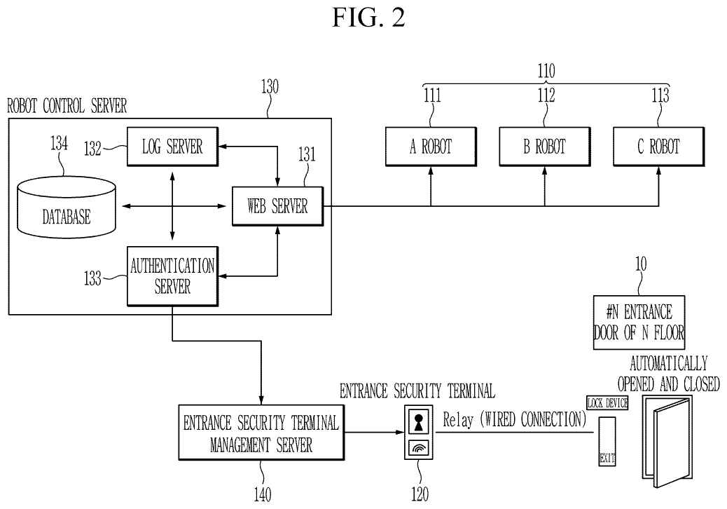

FIG. 2 is a block diagram including an operation sequence of the entrance security management apparatus of the self-driving robot according to an example embodiment of the disclosure. Descriptions are given with reference to FIG. 1.

In FIG. 2, when the robot 110 approaches a target entrance door to pass through, the robot control server 130 may transmit an opening request (e.g., API call) for the entrance security terminal 120 mapped to a corresponding point of interest (POI) to the entrance security terminal management server 140.

The robot 110 may include a plurality of robots. For example, the robot 110 may include the A robot 111, the B robot 112, and the C robot 113. The robot control server 130 may control the A robot 111, the B robot 112, and the C robot 113 in an integrated manner.

The robot control server 130 may include a web server 131, a log server 132, an authentication server 133, and a database 134.

The web server 131 may provide a service for opening the entrance door by linking with a queue management and entrance security terminal management server 140 for passage of the robot 110 through the entrance door 10.

The log server 132 may record an operation and status of servers including the web server 131 and the authentication server 133, the robot 110, and the opening information of the entrance door 10, and/or the like.

The authentication server 133 is responsible for authentication when the robot 110 or the robot control server 130 accesses the entrance security terminal management server 140.

The database 134 includes robot POI and location management information. The database 134 includes matching information on the entrance door and the location of the robot. The matching information may be generated using the entrance door ID and/or the entrance security terminal ID. The entrance door ID and/or the entrance security terminal ID of each entrance door may be predefined.

The entrance security terminal management server 140 may transmit an opening command to the entrance security terminal 120 of the entrance door 10 that received the opening request.

The entrance door 10 and the entrance security terminal 120 may be connected by at least one wire.

The entrance security terminal 120 that received the opening command may open the entrance door 10 that has been requested to be opened through a wired relay signal.

The entrance security management apparatus 100 of a self-driving robot may open and close the entrance door 10 by utilizing the entrance security terminal 120 that has already been installed for other purposes without incurring additional costs in the case of a building in which the entrance security terminal 120 is installed. The entrance security management apparatus 100 of a self-driving robot may control the opening and closing of the entrance door 10 by utilizing the entrance security terminal 120 regardless of the type of the entrance door.

The entrance security management apparatus 100 of a self-driving robot may (e.g., collectively) control the entrance door 10 through the entrance security terminal 120 and the entrance security terminal management server 140, regardless of an entrance door company, an entrance door model, and whether an API server is supported.

The entrance security management apparatus 100 of a self-driving robot may perform log management and integrated control at a server stage through the robot control server 130 and the entrance security terminal management server 140.

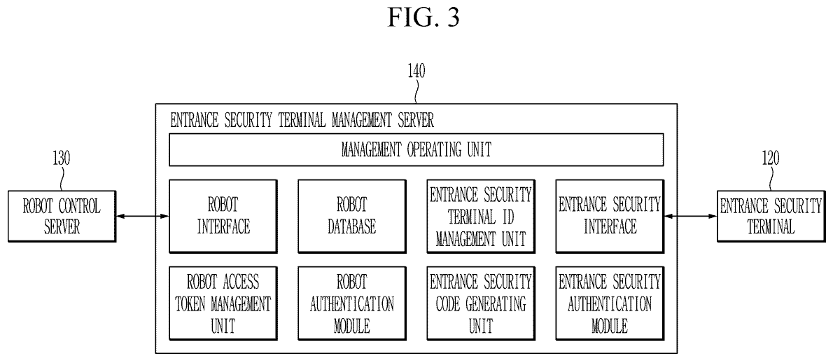

FIG. 3 is a block diagram of an entrance security terminal management server according to an example embodiment of the disclosure.

The entrance security terminal management server 140 may include a robot interface, a robot access token management unit, a robot database, a robot authentication module, an entrance security terminal ID management unit, an entrance security code generating unit, an entrance security interface, and an entrance security approval module in a management operating unit.

The robot interface may be an interface module for mutual connection between individual robots. The robot interface may be linked with the robot control server 130.

The robot access token management unit may manage an access token for accessing the entrance security terminal 120 of the robot.

The robot database, a database linked to the entrance security terminal 120, may store the received information on the robot (such as the robot 110 in FIG. 1).

The robot authentication module may be an authentication module for the robot for approving the use of the entrance security terminal 120.

The entrance security terminal ID management unit may manage the ID of the entrance security terminal.

The entrance security code generating unit may generate a specific approval code for linking and using the entrance security terminal 120 of the robot 110.

The entrance security interface may include an interface module for interoperability with the (e.g., directly) connected entrance security terminal 120.

The entrance security approval module may be a (e.g., dedicated) module for approving a scan on the entrance security terminal 120.

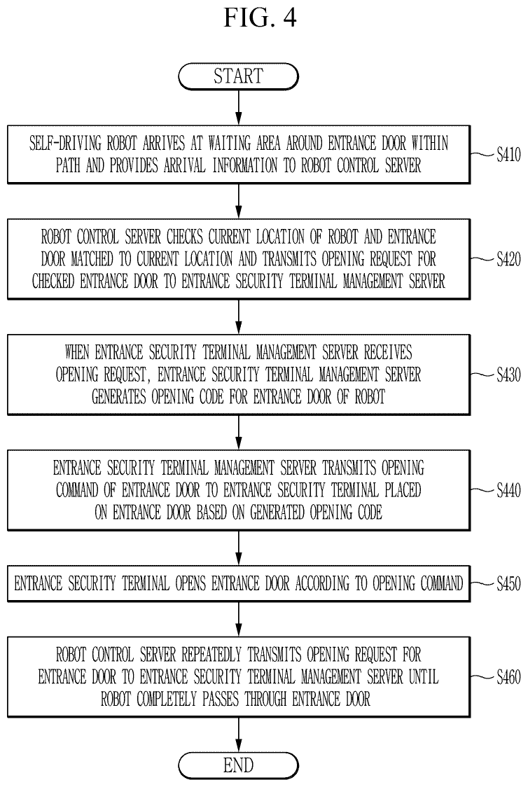

FIG. 4 is a flowchart illustrating an entrance security management method of a self-driving robot according to an example embodiment of the disclosure. The entrance security management method of a self-driving robot of FIG. 4 may be performed through the entrance security management apparatus 100 of a self-driving robot of FIG. 1. Descriptions are given with reference to FIGS. 1 and 2.

In FIG. 4, the self-driving robot 110 may arrive at a waiting area around the entrance door 10 within a path and provide arrival information to the robot control server 130 (e.g., operation S410).

For example, the robot 110 may (e.g., autonomously) drive to a destination through navigation or slam.

The robot 110 may check information on the entrance door 10 located within the (e.g., autonomous) driving path in advance.

The robot 110 may request approval for the ID (e.g., doorID) of the matched entrance security terminal 120 after arriving at a POI or waiting area in front of the entrance door 10 that the robot 110 is requesting to pass through.

The robot control server 130 may check the current location of the robot 110 and the entrance door 10 matched to the current location and transmit an opening request for the checked entrance door 10 to the entrance security terminal management server 140 (e.g., operation S420).

The robot control server 130 may transmit a request for approval of the terminal and opening of the entrance door 10 to the entrance security terminal management server 140.

When the entrance security terminal management server 140 receives the opening request, the entrance security terminal management server 140 may generate an opening code for the entrance door 10 of the robot 110 (e.g., operation S430).

The entrance security terminal management server 140 may accept the opening request for an external entrance door by the robot 110 and generate an opening token or an opening code (e.g., access token/code).

The entrance security terminal management server 140 may transmit an opening command of the entrance door 10 to the entrance security terminal 120 placed on the entrance door 10 based on the generated opening code (e.g., operation S440).

According to the opening command, the entrance security terminal 120 may open the entrance door 10 (e.g., connected by wire) through a relay signal (e.g., operation S450).

In an example embodiment, the entrance security terminal management server 140 may approve the entry of the robot 110 and open the entrance security terminal 120 of the corresponding entrance door 10.

The robot control server 130 may (e.g., repeatedly) transmit an opening request for the entrance door 10 to the entrance security terminal management server 140 until the robot 110 (e.g., completely) passes through the entrance door 10 (e.g., operation S460).

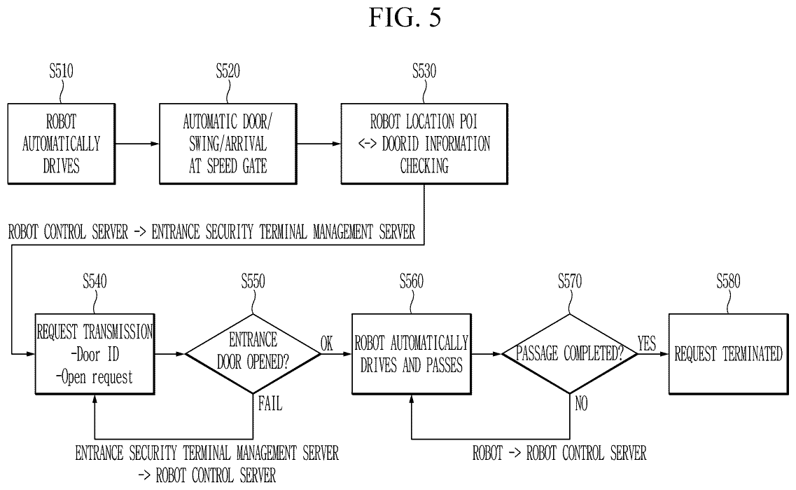

FIG. 5 is a flowchart of an entrance security management method of a self-driving robot according to an example embodiment of the disclosure. Descriptions are given with reference to FIGS. 1 and 2.

The robot 110 (e.g., autonomously) drives along the path (e.g., operation S510).

When the robot 110 arrives at the waiting area in front of or around the entrance door 10 that the robot 110 is requesting to pass through, the robot 110 may transmit the arrival information in the waiting area to the robot control server 130 (e.g., operation S520).

The robot control server 130 may check the entrance door 10 matched to the received current location value (e.g., the POI) of the robot 110 or the ID (e.g., doorID) of the entrance security terminal 120 (e.g., operation S530). In an example embodiment, the POI may be provided in coordinates such as (X, Y) and the doorID may be a numeral, such as 1001 (e.g., doorID: 1001)).

The robot control server 130 may transmit an opening request for opening the entrance door 10 together with the passage information of the robot 110 to the entrance security terminal management server 140 through a representational state transfer (REST) API (e.g., operation S540).

The robot control server 130 transmits robot information including a robot code for the robot along with the opening request for the entrance door as passage information. The robot control server 130 transmits entrance security terminal information including the entrance security terminal ID for the entrance door.

The entrance security terminal management server 140 may check the robot information based on the received passage information, turn on a relay contact of the entrance security terminal 120 to open the entrance door 10, and transmit a result (e.g., response) to the robot control server 130 (e.g., operation S550).

The entrance security terminal 120 opens the entrance door 10 and transmits the opening result to the entrance security terminal management server 140.

The entrance security terminal management server 140 provides the received opening result to the robot control server 130.

In an example embodiment, the entrance security terminal management server 140 determines whether to approve opening based on the robot code and the entrance door ID, and if approved, may generate an opening code.

If the opening request is not approved, the entrance security terminal management server 140 may transmit a corresponding result (e.g., FAIL) to the robot control server 130.

After checking the opening result Response (e.g., success) for opening the entrance door 10, the robot control server 130 transmits the corresponding information to the robot 110, and the robot 110 passes through the opened entrance door (e.g., operation S560).

In an example embodiment, the robot control server 130 may repeat the opening request within a set timeout of the entrance door 10 until the robot 110 (e.g., completely) passes through the entrance door 10 in order to prevent the entrance door 10 from being closed due to the timeout.

When the robot 110 completes passage and entry, the robot 110 transmits completion information to the robot control server 130 (e.g., operation S570).

Thereafter, upon receiving the completion information, the robot control server 130 may stop the repeated opening request (e.g., operation S580).

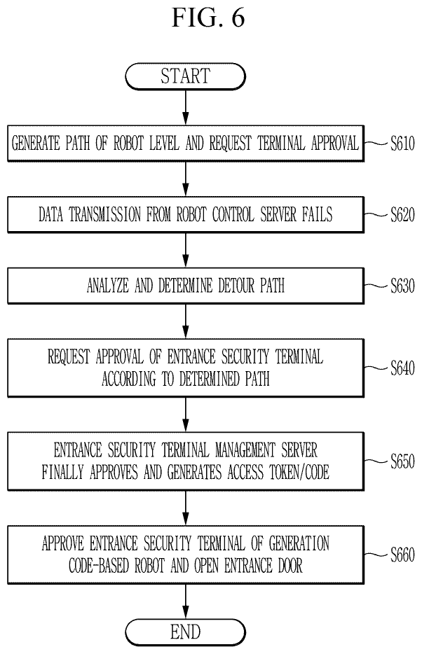

FIG. 6 is a flowchart of an entrance security management method of a self-driving robot according to another example embodiment of the disclosure. The entrance security management method of a self-driving robot of FIG. 6 may be performed through the entrance security management apparatus 100 of a self-driving robot of FIG. 1.

In FIG. 6, the entrance security management apparatus 100 of a self-driving robot may generate an (e.g., autonomous) driving path at the robot 110 level and request approval from the entrance security terminal 120 (e.g., operation S610).

When the self-driving robot 110 arrives at a waiting area adjacent to the entrance door located within the existing path, the entrance security management apparatus 100 of a self-driving robot may transmit arrival information including the current location of the robot and an approval request for the entrance security terminal 120 matched to the corresponding entrance door to the robot control server 130.

If data transmission for the approval request fails due to a wireless network delay in the robot control server 130 (e.g., operation S620), the entrance security management apparatus 100 of a self-driving robot may analyze other detour paths and the robot 110 may proceed along a determined detour path (e.g., operation S630).

In an example embodiment, the entrance security management apparatus 100 of a self-driving robot may reset the autonomous driving path to a path that passes through another entrance door on the same floor.

The entrance security management apparatus 100 of a self-driving robot may re-proceed with an approval request for the entrance security terminal 120 according to the determined path (e.g., operation S640).

When the entrance security management apparatus 100 of a self-driving robot arrives at a waiting area (e.g., POI) in front of another entrance door, the entrance security management apparatus 100 of a self-driving robot may request approval for the entrance security terminal of the corresponding entrance door again from the robot control server 130.

The entrance security management apparatus 100 of a self-driving robot may (e.g., finally) approve the entrance door of the detour path through the entrance security terminal management server 140 and generate a robot approval token (Access Token) and an entrance security terminal approval code (Access Code) (e.g., operation S650).

The entrance security management apparatus 100 of a self-driving robot may approve the opening request to the entrance security terminal 120 of the robot based on the generated code and open the entrance door (e.g., operation S660).

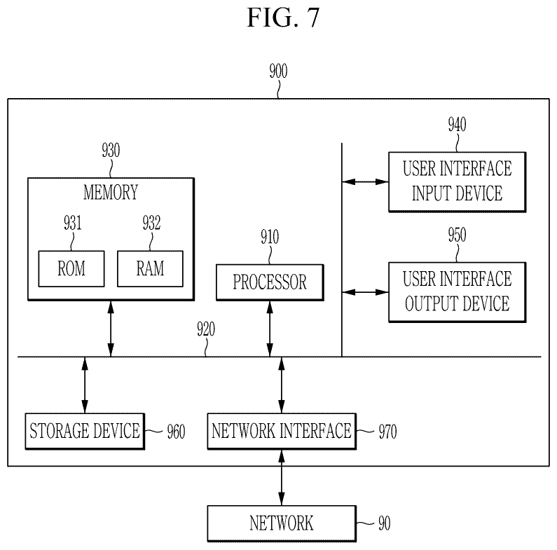

FIG. 7 is a diagram illustrating a computing device according to an example embodiment of the disclosure.

Referring to FIG. 7, the entrance security management apparatus and method of a self-driving robot according to example embodiments may be implemented using a computing device 900. For example, the entrance security terminal management server 140 and the robot control server 130 may be implemented as the computing device 900.

The computing device 900 may include at least one of a processor 910, a memory 930, a user interface input device 940, a user interface output device 950, and a storage device 960 communicating via a bus 920. The computing device 900 may also include a network interface 970 electrically connected to a network 90. The network interface 970 may transmit or receive signals to or from other entities via the network 90.

The processor 910 may be implemented with one or more components, such as a micro-controller unit (MCU), an application processor (AP), a central processing unit (CPU), a graphics processing unit (GPU), a neural processing unit (NPU), and/or the like, and may be any semiconductor device that executes instructions stored in the memory 930 or the storage device 960. The processor 910 may be configured to implement the functions and methods described above with reference to FIGS. 1 to 6.

The memory 930 and the storage device 960 may include various types of volatile or nonvolatile storage mediums. For example, the memory may include read-only memory (ROM) 931 and random access memory (RAM) 932. In an example embodiment, the memory 930 may be located within or separate from the processor 910, and the memory 930 may be connected to the processor 910 through one or more components.

In some example embodiments, at least some of the components or functions of the entrance security management apparatus and method for a self-driving robot according to example embodiments may be implemented as a program or software that runs on the computing device 900, and the program or software may be stored on a computer-readable medium.

In some example embodiments, at least one or more of the components or functions of the entrance security management apparatus and method for a self-driving robot according to example embodiments may be implemented using hardware or circuitry of the computing device 900 or may be implemented as separate hardware or circuitry that may be electrically connected to the computing device 900.

While the disclosure has been described in connection with example embodiments, the disclosure is not limited to the disclosed example embodiments and may cover various modifications and equivalent arrangements.

What is claimed is:

1. An entrance security management apparatus comprising:
a robot that autonomously drives along a path;
an entrance security terminal placed at an entrance door in a building configured to control opening and closing of the entrance door;
a robot control server configured to check a current location of the robot, to check whether the entrance door matches the current location, and to transmit an opening request for the entrance door; and
an entrance security terminal management server configured to generate an opening code for the entrance door upon receiving the opening request and to transmit an opening command for the entrance door to the entrance security terminal based on the generated opening code.

2. The entrance security management apparatus of claim 1, wherein:
when the robot arrives at a first waiting area adjacent to a first entrance door located within a first path, the robot is configured to transmit an approval request for a first entrance security terminal matched to the first entrance door to the robot control server along with arrival information including the current location.

3. The entrance security management apparatus of claim 2, wherein:
when transmission of the approval request fails due to wireless network delay, the robot is configured to set a second path passing through a second entrance door on the same floor, and when the robot arrives at a second waiting area adjacent to the second entrance door, the robot is configured to retransmit an approval request for a second entrance security terminal matched to the second entrance door to the robot control server along with arrival information including a current location.

4. The entrance security management apparatus of claim 1, wherein:
the entrance security terminal is configured to control opening and closing of the entrance door through a wired relay connection to the entrance door.

5. The entrance security management apparatus of claim 1, wherein:
the robot control server is configured to transmit robot information including a robot code for the robot and entrance security terminal information including an entrance security terminal ID for the entrance door together with the opening request for the entrance door.

6. The entrance security management apparatus of claim 5, wherein:
the entrance security terminal management server is configured to determine whether to approve opening based on the robot code and the entrance security terminal ID, and when approved, to generate the opening code.

7. The entrance security management apparatus of claim 1, wherein:
the entrance security terminal is configured to open the entrance door according to the opening command and transmits an opening result to the entrance security terminal management server, and the entrance security terminal management server is configured to provide the opening result to the robot control server.

8. The entrance security management apparatus of claim 7, wherein:
the robot control server, upon receiving the opening result, is configured to transmit the opening result to the robot, and upon receiving the opening result, the robot passes through the entrance door.

9. The entrance security management apparatus of claim 1, wherein:
the robot control server is configured to repeatedly transmit a request to open the entrance door to the entrance security terminal management server until the robot completely passes through the entrance door.

10. The entrance security management apparatus of claim 9, wherein:
when the robot passes through the entrance door completely, the robot is configured to transmit passage completion information to the robot control server, and
when the robot control server receives the passage completion information, the robot control server is configured to stop the repeated transmission of the opening request.

11. An entrance security management method comprising:
providing arrival information of a self-driving robot to a robot control server when the self-driving robot arrives at a waiting area at or near an entrance door within a path;
checking a current location of the robot via the robot control server, checking whether an entrance door matches the current location, and transmitting an opening request for the entrance door to an entrance security terminal management server;
generating an opening code for the entrance door via the entrance security terminal management server when the opening request is received;
transmitting an opening command for the entrance door to an entrance security terminal placed at the entrance door based on the generated opening code; and
opening the entrance door, via the entrance security terminal, according to the opening command.

12. The entrance security management method of claim 11, wherein:
providing the arrival information from the robot to the robot control server includes,
when the robot arrives at a first waiting area adjacent to a first entrance door located within a first path, the robot transmits arrival information including the current location and an approval request for a first entrance security terminal matched to the first entrance door to the robot control server.

13. The entrance security management method of claim 12, wherein:
providing the arrival information from the robot to the robot control server further includes,
when transmission of the approval request fails due to wireless network delay, the robot sets a second path passing through a second entrance door on the same floor, and when the robot arrives at a second waiting area adjacent to the second entrance door, the robot retransmits arrival information including a current location and an approval request for a second entrance security terminal matched to the second entrance door to the robot control server.

14. The entrance security management method of claim 11, wherein:
opening the entrance door, via the entrance security terminal, according to the opening command includes opening the entrance door through a wired relay connection.

15. The entrance security management method of claim 11, wherein:
transmitting the opening request for the entrance door via the entrance security terminal management server includes
transmitting, via the robot control server, robot information including a robot code for the robot and entrance security terminal information including an entrance security terminal ID for the entrance door together with the opening request for the entrance door.

16. The entrance security management method of claim 15, wherein:
generating an opening code for the entrance door, via the entrance security terminal management server, includes
determining whether to approve opening based on the robot code and the entrance security terminal ID and, when approved, generating the opening code.

17. The entrance security management method of claim 11, further comprising:
transmitting an opening result to the entrance security terminal management server when the entrance door is opened via the entrance security terminal, and
providing the received opening result to the robot control server via the entrance security terminal management server.

18. The entrance security management method of claim 17, further comprising:
when the opening result is received, transmitting the opening result to the robot via the entrance security terminal management server; and
passing the robot through the entrance door when the opening result is received.

19. The entrance security management method of claim 11, wherein:
transmitting, via the robot control server, the opening request for the entrance door to the entrance security terminal management server includes
repeatedly transmitting, via the robot control server, the opening request for the entrance door to the entrance security terminal management server until the robot completely passes through the entrance door.

20. The entrance security management method of claim 19, wherein:
repeatedly transmitting, via the robot control server, the opening request for the entrance door to the entrance security terminal management server until the robot completely passes through the entrance door includes:
transmitting, via the robot, passage completion information to the robot control server when the robot completely passes through the entrance door; and
stopping the repeated transmission of the opening request when the robot control server receives the passage completion information.
